(19) United States
(12) Patent Application Publication
(10) Pub. No.: US 2026/0158825 A1
(43) Pub. Date: Jun. 11, 2026

(54) TIRE

(71) Applicant: The Yokohama Rubber Co., LTD., Kanagawa (JP)

(72) Inventor: Hideki HAMANAKA, Kanagawa (JP)

(21) Appl. No.: 19/406,053

(22) Filed: Dec. 2, 2025

(30) Foreign Application Priority Data
Dec. 9, 2024 (JP) 2024-214439

(51) Int. Cl. B60C 9/20; B60C 11/03; B60C 11/13

(52) U.S. Cl. CPC B60C 9/20; B60C 11/13; B60C 2009/2012; B60C 2009/2016; B60C 2009/2019; B60C 2009/2022; B60C 2011/0348; B60C 2011/0353; B60C 2200/06

(57) ABSTRACT

A tire includes a tread portion including circumferential main grooves extending in a tire circumferential direction; and a belt layer including belt plies. The belt layer includes a circumferential reinforcing layer disposed between a pair of cross belts, having a width in a tire width direction smaller than a width of the cross belts, and having an inclination angle of the belt cords with respect to the tire circumferential direction of 5 degrees or less. The tread portion includes a shoulder portion narrow groove disposed on an outer side in the tire width direction of a circumferential main groove and extending in the tire circumferential direction. A distance WC from a tire equatorial plane to an end portion in the tire width direction of the circumferential reinforcing layer and a distance WN from the tire equatorial plane to the shoulder portion narrow groove satisfy 0.50≤WC/WN≤0.90.

### CROSS-REFERENCE TO RELATED APPLICATION

This application claims priority pursuant to 35 U.S.C. 119 (a) to Japanese Patent Office Application No. 2024-214439, filed Dec. 9, 2024, which application is incorporated herein by reference in its entirety.

### TECHNICAL FIELD

The present technology relates to a tire.

### BACKGROUND

A tire has a belt layer as a reinforcing layer in a tread portion. The tread portion has increased rigidity due to the belt layer, and performance of known tires has been improved by devising the belt layer. For example, in a heavy duty pneumatic tire described in Japan Unexamined Patent Publication No. 10-250314 A, a belt has two or more cord crossing layers near a carcass and two or more substantially inextensible circumferentially arranged cord layers on an outer circumferential side thereof. In a tire described in Japan Unexamined Patent Publication No. 2023-048304 A, a belt layer is formed by layering a plurality of belt plies including a high-angle belt, a pair of cross belts, and a belt cover.

Here, in a tire used under a long-haul operation mainly involving high-speed continuous traveling, the tire cannot be used until the end of its service life due to the occurrence of uneven wear, and the tire may need to be removed and replaced at an early stage before the service life. As a method for improving the uneven wear resistance of such a tire, for example, a method of suppressing uneven wear by disposing a circumferential reinforcing layer, in which cords extend along a tire circumferential direction, in a belt layer to suppress radial growth during vehicle traveling and suppress slippage of a ground contact surface is exemplified. As another method, a method of improving uneven wear of a shoulder portion by disposing narrow grooves communicating in a tire circumferential direction at or near the shoulder portion in a tread portion as described in Patent Document 2 to alleviate a ground contact pressure at or near shoulder end portions in the tread portion is exemplified. In order to improve the uneven wear resistance of the tire, it is conceivable to effectively suppress the uneven wear of the tread portion by combining these methods.

However, when the circumferential reinforcing layer is disposed in the belt layer, the rigidity of the tread portion increases in a region in a tire width direction where the circumferential reinforcing layer is disposed, whereas the rigidity of the tread portion decreases relatively in a portion on an outer side in the tire width direction of the region where the circumferential reinforcing layer is disposed. When the narrow grooves communicating in the tire circumferential direction are disposed at or near the shoulder portion, if the rigidity of the portion on the outer side in the tire width direction of the region where the circumferential reinforcing layer is disposed relatively decreases, the magnitude of a load with respect to the rigidity is likely to increase at or near the shoulder portion due to the rigidity difference in the tread portion. In this case, there is a risk that damage such as a rib tear starting from the narrow groove disposed in the shoulder portion is likely to occur at or near the shoulder portion. Therefore, it is difficult to suppress uneven wear of the tread portion without causing damage such as a rib tear in the shoulder portion.

### SUMMARY

The present technology provides a tire that can provide improved uneven wear resistance while providing a suppressed rib tear in a shoulder region.

A tire according to the present technology includes: a tread portion including a plurality of circumferential main grooves extending in a tire circumferential direction; and a belt layer disposed in the tread portion and including a plurality of belt plies. The belt layer includes a pair of cross belts each including belt cords whose inclination directions toward a tire width direction with respect to a tire circumferential direction are opposite to each other, and a circumferential reinforcing layer disposed between the pair of cross belts, having a width in the tire width direction smaller than a width of the cross belts, and having an inclination angle of the belt cords in the tire width direction with respect to the tire circumferential direction of 5 degrees or less. The tread portion includes a shoulder portion narrow groove disposed on an outer side in the tire width direction of a circumferential main groove of the circumferential main grooves and extending in the tire circumferential direction. A distance in the tire width direction from a tire equatorial plane to an end portion in the tire width direction of the circumferential reinforcing layer is defined as W_{C}, a distance in the tire width direction from the tire equatorial plane to an end portion on an inner side in the tire width direction of the shoulder portion narrow groove is defined as W_{N}, and a distance W_{C} and a distance W_{N} satisfy a relationship 0.50≤W_{C}/W_{N}≤0.90.

The tire according to an embodiment of the present technology exerts the effect that can provide improved uneven wear resistance while providing a suppressed rib tear in a shoulder region.

### BRIEF DESCRIPTION OF THE DRAWINGS

FIG. 1 is a tire meridian cross-sectional view illustrating a main portion of a pneumatic tire according to an embodiment;

FIG. 2 is a schematic diagram illustrating a belt layer illustrated in FIG. 1;

FIG. 3 is a plan view of a tread portion illustrated in FIG. 1;

FIG. 4 is a detailed view of the tread portion illustrating a region on one side from a tire equatorial plane in a tire width direction of the tread portion illustrated in FIG. 1;

FIG. 5 is a detailed view of a shoulder portion narrow groove illustrated in FIG. 4; and,

FIG. 6A-6F include tables indicating results of performance evaluation tests of pneumatic tires.

### DETAILED DESCRIPTION

The embodiments according to the present technology will be described in detail below with reference to the drawings. The technology is not limited to the embodiments. Constituents of the embodiments include elements that are substitutable while maintaining consistency with the technology, and obviously substitutable elements. The plurality of modified examples described in the embodiments can be combined as desired within the scope apparent to one skilled in the art.

### EMBODIMENTS

In the following description, the term “tire radial direction” refers to a direction orthogonal to the tire rotation axis (not illustrated), which is a rotation axis of a pneumatic tire 1 of the embodiment, the term “inner side in the tire radial direction” refers to a side toward the tire rotation axis in the tire radial direction, and the term “outer side in the tire radial direction” refers to a side away from the tire rotation axis in the tire radial direction. The term “tire circumferential direction” refers to a circumferential direction with the tire rotation axis as a center axis. The term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The term “tire equator line” refers to a line in the tire circumferential direction of the pneumatic tire 1 that lies on the tire equatorial plane CL. The term “cross-section in the tire meridian direction (meridian cross-sectional view)” refers to a cross section of the tire taken along a plane that includes the tire rotation axis.

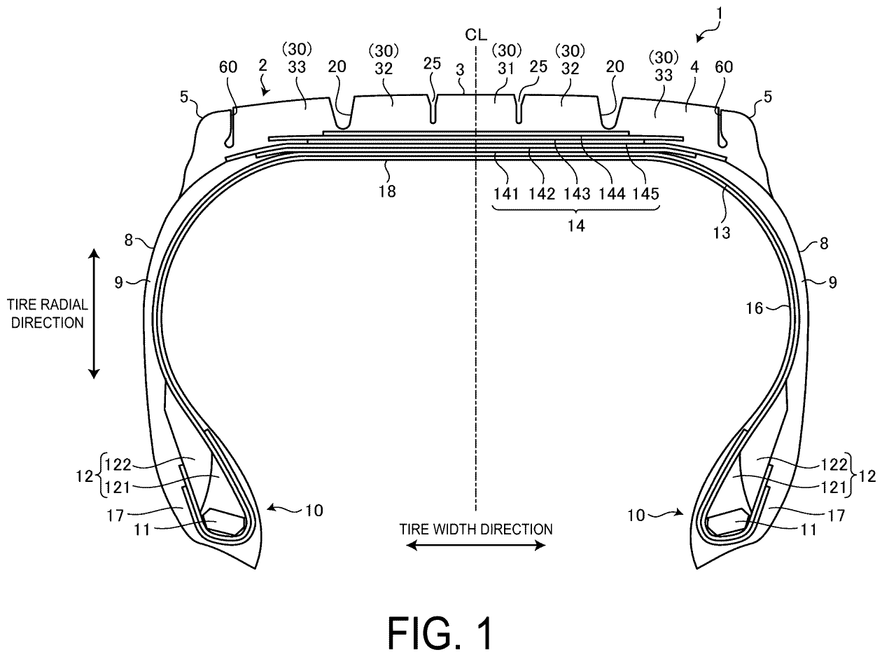

FIG. 1 is a tire meridian cross-sectional view illustrating a main portion of the pneumatic tire 1 according to an embodiment. FIG. 1 illustrates a meridional cross section of the pneumatic tire 1 according to an embodiment, the cross section of one side region of a tire rotation axis in a tire radial direction. In the present embodiment, a heavy duty pneumatic radial tire mounted on a long-distance transport vehicle such as a truck or bus will be described as an example.

In the pneumatic tire 1 according to the present embodiment, a tread portion 2 is disposed on a portion on the outermost side in the tire radial direction when viewed in a tire meridian cross-section, and the tread portion 2 includes a tread rubber 4 made of a rubber composition. The surface of the tread portion 2, that is, a portion that comes into contact with road surfaces during traveling of a vehicle (not illustrated) on which the pneumatic tires 1 are mounted is formed as a tread ground contact surface 3, and the tread ground contact surface 3 forms a portion of a contour of the pneumatic tire 1.

Shoulder portions 5 are positioned at both ends on outer sides of the tread portion 2 in the tire width direction, and sidewall portions 8 are disposed on inner sides in the tire radial direction of the shoulder portions 5. In other words, the sidewall portions 8 are disposed on both sides in the tire width direction of the tread portion 2. In other words, the sidewall portions 8 are disposed at two sections on both sides in the tire width direction of the pneumatic tire 1 and form portions exposed to the outermost sides in the tire width direction of the pneumatic tire 1. The sidewall portion 8 includes a sidewall rubber 9 made of a rubber composition.

A bead portion 10 is provided on an inner side in the tire radial direction of each of the sidewall portions 8 located on both sides in the tire width direction. Similarly to the sidewall portions 8, the bead portions 10 are disposed at two sections on both sides of the tire equatorial plane CL. That is, a pair of the bead portions 10 is disposed on both sides in the tire width direction of the tire equatorial plane CL. The bead portions 10 each includes a bead core 11, and a bead filler 12 is provided on an outer side in the tire radial direction of the bead core 11.

The bead core 11 is an annular member formed in an annular shape by bundling bead wires, which are steel wires, and winding them multiple times. The bead fillers 12 include a lower filler 121 and an upper filler 122, which are rubber members, are respectively disposed on outer sides in the tire radial direction of the bead cores 11 and reinforce the bead portions 10.

A carcass layer 13 containing cords of radial plies is continuously provided on an inner side in the tire radial direction of the tread portion 2 and on a tire equatorial plane CL side of the sidewall portions 8. Accordingly, the pneumatic tire 1 according to the present embodiment is configured as a so-called radial tire. The carcass layer 13 has a single layer structure made of one carcass ply or a multilayer structure made of a plurality of carcass plies layered, and spans between the pair of bead portions 10 disposed on both sides in the tire width direction in a toroidal shape to form a framework of the tire.

Specifically, the carcass layer 13 is disposed to span from one bead portion 10 to the other bead portion 10 of the pair of bead portions 10 located on both sides in the tire width direction and is turned back toward the outer side in the tire width direction along the bead cores 11 at the bead portions 10 so as to wrap around the bead cores 11 and the bead fillers 12. The bead filler 12 is a rubber member disposed in a space on the outer side in the tire radial direction of the bead core 11, the space being formed by folding the carcass layer 13 back at the bead portion 10. The carcass ply of the carcass layer 13 is made by coating, with coating rubber, and rolling a plurality of carcass cords made of steel or an organic fiber material such as aramid, nylon, polyester, or rayon. The plurality of carcass cords forming the carcass ply are disposed in parallel at an angle in the tire circumferential direction, the angle with respect to the tire circumferential direction being along a tire meridian direction.

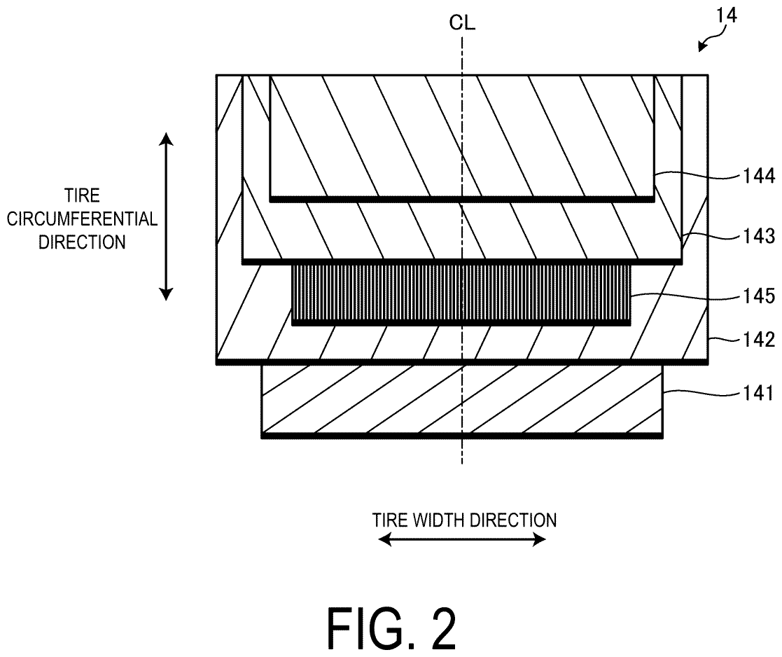

A belt layer 14 is disposed in the tread portion 2. FIG. 2 is a schematic diagram illustrating the belt layer 14 illustrated in FIG. 1. The belt layer 14 is disposed on the outer side in the tire radial direction of a portion, located in the tread portion 2, of the carcass layer 13 spanning between the pair of bead portions 10. The belt layer 14 is formed by layering a plurality of belt plies 141 to 145 and is disposed around an outer circumference of the carcass layer 13. The belt plies 141 to 145 including a large-angle belt 141, a pair of cross belts 142 and 143, a belt cover 144, and a circumferential reinforcing layer 145.

The large-angle belt 141 is formed by covering a plurality of belt cords made of steel wire with a coating rubber and performing a rolling process thereon and has a cord angle (defined as an inclination angle in a longitudinal direction of the belt cord with respect to the tire circumferential direction) of 45 degrees or more and 70 degrees or less, preferably 54 degrees or more and 68 degrees or less as an absolute value. The large-angle belt 141 is disposed in a layered manner on an outer side in the tire radial direction of the carcass layer 13.

The pair of cross belts 142 and 143 are formed by covering a plurality of belt cords made of steel wire with a coating rubber and performing a rolling process thereon and have cord angles of 10 degrees or more and 45 degrees or less, preferably 14 degrees or more and 28 degrees or less as an absolute value. The pair of cross belts 142 and 143 have cord angles having mutually opposite signs and is layered by making the belt cords mutually intersect in the longitudinal direction of the belt cords (a so-called crossply structure is formed). That is, inclination directions of the belt cords of the pair of cross belts 142 and 143, toward the tire width direction with respect to the tire circumferential direction, are opposite to each other. The pair of cross belts 142 and 143 are disposed in a layered manner on the outer side in the tire radial direction of the large-angle belt 141. Here, the cross belt 142 located on the inner side in the tire radial direction is defined as an inner cross belt, and the cross belt 143 located on the outer side in the tire radial direction is defined as an outer cross belt.

The belt cover 144 is formed by covering a plurality of belt cover cords made of steel wire or organic fiber material with a coating rubber and performing a rolling process thereon and has a cord angle of 10 degrees or more and 45 degrees or less, preferably 14 degrees or more and 28 degrees or less as an absolute value. The belt cover 144 is disposed in a layered manner on an outer side in the tire radial direction of the cross belts 142 and 143. In the present embodiment, the belt cover 144 has the same cord angle as the outer cross belt 143 and is disposed in the outermost layer of the belt layer 14.

The circumferential reinforcing layer 145 is made by spirally winding a belt cord made of steel wire covered with a coating rubber in the tire circumferential direction and has a cord angle of 5 degrees or less as an absolute value. That is, an inclination angle of the belt cord of the circumferential reinforcing layer 145 toward the tire width direction with respect to the tire circumferential direction is 5 degrees or less. The circumferential reinforcing layer 145 is disposed between the pair of cross belts 142 and 143. The circumferential reinforcing layer 145 is formed with a width in the tire width direction that is narrower than widths of the cross belts 142 and 143 in the tire width direction. Therefore, the circumferential reinforcing layer 145 is disposed on an inner side in the tire width direction of end portions on both sides in the tire width direction of the pair of cross belts 142 and 143. Specifically, the circumferential reinforcing layer 145 is formed by spirally winding one or a plurality of wires on the outer circumference of the inner cross belt 142. The circumferential reinforcing layer 145 is continuously disposed in the tire width direction to go across the tire equatorial plane CL in the tire width direction.

In the present embodiment, the circumferential reinforcing layer 145 has several ends of the belt cords, that is, a number of the belt cords per unit width, within a range of 15 cords/50 mm or more and 30 cords/50 mm or less. An outer diameter of the belt cord is within a range 1.2 mm or more and 2.2 mm or less. In a configuration in which the belt cords are made of a plurality of cords twisted together, a diameter of a circle that circumscribes the belt cord is measured as the outer diameter of the belt cord.

At the bead portion 10, a rim cushion rubber 17 that forms a contact surface of the bead portion 10 with respect to a rim flange is disposed on the inner side in the tire radial direction and the outer side in the tire width direction of the bead core 11 and a turned back portion of the carcass layer 13. An innerliner 16 is formed along the carcass layer 13 on the inner side of the carcass layer 13 or on the inner portion side of the carcass layer 13 in the pneumatic tire 1. The innerliner 16 forms a tire inner surface 18 that is a surface on the inner side of the pneumatic tire 1.

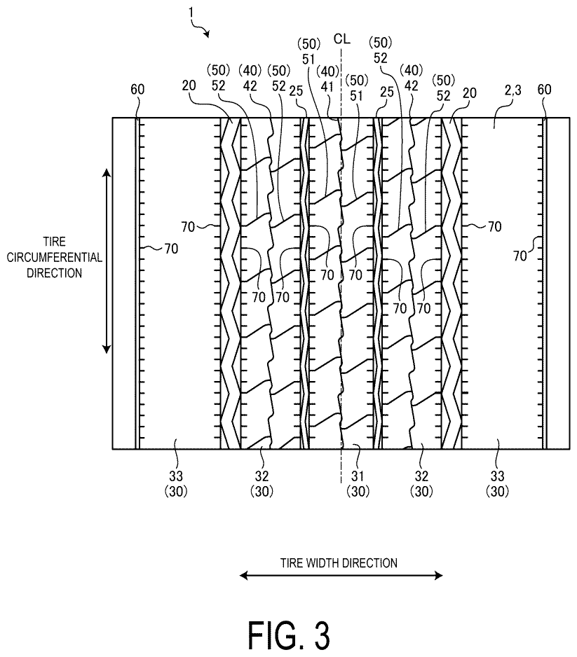

FIG. 3 is a plan view of the tread portion 2 illustrated in FIG. 1. A plurality of circumferential main grooves 20 extending in the tire circumferential direction are disposed in the tread ground contact surface 3 in the tread portion 2, and a plurality of land portions 30 are defined by the plurality of circumferential main grooves 20 on the surface of the tread portion 2. In the present embodiment, only two circumferential main grooves 20 are disposed. The two circumferential main grooves 20 are disposed one on each side of the tire equatorial plane CL in the tire width direction.

The circumferential main groove 20 referred to herein is a longitudinal groove extending in the tire circumferential direction and internally having a wear indicator (slip sign) indicative of terminal stages of wear. The circumferential main grooves 20 formed in the above-described manner have a groove width within a range of 5.0 mm or more and 18.0 mm or less, and a groove depth within a range of 10.0 mm or more and 20.0 mm or less.

A plurality of chamfered circumferential narrow grooves 25 extending in the tire circumferential direction are disposed in the tread ground contact surface 3 in the tread portion 2. The chamfered circumferential narrow groove 25 is a circumferential groove extending in the tire circumferential direction with a groove width narrower than that of the circumferential main groove 20, and an opening portion with respect to the tread ground contact surface 3 is chamfered. The chamfered circumferential narrow groove 25 does not have a wear indicator, and a portion of the chamfered circumferential narrow groove 25, on a groove bottom side with respect to the chamfered portion, has a groove width of less than 5.0 mm.

Two chamfered circumferential narrow grooves 25 are provided, and the two chamfered circumferential narrow grooves 25 are disposed one on each side of the tire equatorial plane CL in the tire width direction. Specifically, the chamfered circumferential narrow grooves 25 are disposed on an inner side with respect to the circumferential main groove 20 in the tire width direction. Therefore, in other words, the two chamfered circumferential narrow grooves 25 are disposed one on each side of the tire equatorial plane CL, and the two circumferential main grooves 20 are disposed one on each outer side of the two chamfered circumferential narrow grooves 25 in the tire width direction.

The circumferential main grooves 20 and the chamfered circumferential narrow grooves 25 disposed side by side in the tire width direction as described above are all formed so as to extend in the tire circumferential direction and have groove bottoms formed to undulate in the tire width direction. That is, in both the circumferential main groove 20 and the chamfered circumferential narrow groove 25, the opening portion with respect to the tread ground contact surface 3 extends in the tire circumferential direction with a position in the tire width direction being a constant position, while the groove bottom is formed in a wave-like shape by extending in the tire circumferential direction and undulating in the tire width direction.

The chamfered circumferential narrow groove 25 defines a land portion 30 of the tread portion 2 together with the circumferential main groove 20. The land portion 30 defined by the circumferential main groove 20 and the chamfered circumferential narrow groove 25 includes a center land portion 31, middle land portions 32, and shoulder land portions 33. The center land portion 31 is the land portion 30 disposed between the two chamfered circumferential narrow grooves 25 and both sides in the tire width direction are each defined by the chamfered circumferential narrow groove 25. The center land portion 31 is disposed on the tire equatorial plane CL.

The middle land portion 32 is the land portion 30 disposed between the circumferential main groove 20 and the chamfered circumferential narrow groove 25 adjacent to each other in the tire width direction, and a portion on the inner side in the tire width direction is defined by the chamfered circumferential narrow groove 25, and a portion on the outer side in the tire width direction is defined by the circumferential main groove 20. Accordingly, the middle land portions 32 are disposed on both sides of the tire equatorial plane CL in the tire width direction.

The shoulder land portion 33 is the land portion 30 disposed on an outer side in tire width direction of the circumferential main groove 20, and an inner portion in the tire width direction is defined by the circumferential main groove 20. Accordingly, the shoulder land portions 33 are disposed on both sides of the tire equatorial plane CL in the tire width direction.

Furthermore, the tread portion 2 includes a shoulder portion narrow groove 60 disposed on an outer side in the tire width direction of the circumferential main groove 20 and extending in the tire circumferential direction. In the shoulder portion narrow groove 60, a groove width of an opening portion with respect to the tread ground contact surface 3 is 4.0 mm or less, and a groove depth is within a range of 10.0 mm or more and 20.0 mm or less. The shoulder portion narrow groove 60 is disposed in the shoulder land portion 33 of the plurality of land portions 30 included in the tread portion 2. Specifically, the shoulder portion narrow groove 60 is disposed at a position at or near an end portion on an outer side in the tire width direction of the shoulder land portion 33.

Multi-sipes 70 are disposed in the land portion 30 of the tread portion 2. The multi-sipe 70 is a short sipe having one end opening to the circumferential groove in each land portion 30 and the other end terminating within the land portion 30. In the present embodiment, a width of the multi-sipe 70 is within a range of 0.3 mm or more and 1.5 mm or less, a depth thereof is within a range of 2.0 mm or more and 17 mm or less, and a length in the extension direction of the multi-sipe 70 is within a range of 2.0 mm or more and 10 mm or less.

The plurality of multi-sipes 70 are disposed in each of the center land portion 31, the middle land portion 32, and the shoulder land portion 33. The plurality of multi-sipes 70 disposed in the center land portion 31 are disposed along two chamfered circumferential narrow grooves 25 that define both sides in the tire width direction of the center land portion 31. That is, the plurality of multi-sipes 70 disposed in the center land portion 31 are formed such that one end thereof is open to the chamfered circumferential narrow groove 25 and the other end thereof terminates within the center land portion 31, and the plurality of multi-sipes 70 are disposed side by side in the tire circumferential direction along the chamfered circumferential narrow groove 25.

The plurality of multi-sipes 70 disposed in the middle land portion 32 are disposed along the circumferential main groove 20 and the chamfered circumferential narrow grooves 25 that define both sides in the tire width direction of the middle land portion 32. That is, the plurality of multi-sipes 70 disposed in the middle land portion 32 are formed such that one end thereof is open to the circumferential main groove 20 or the chamfered circumferential narrow groove 25 and the other end thereof terminates within the middle land portion 32, and the plurality of multi-sipes 70 are disposed side by side in the tire circumferential direction along the circumferential main groove 20 or the chamfered circumferential narrow groove 25.

The plurality of multi-sipes 70 disposed in the shoulder land portion 33 are disposed along the circumferential main groove 20, which define an inner side in the tire width direction of the shoulder land portion 33, and the shoulder portion narrow groove 60 disposed in the shoulder land portion 33. That is, the plurality of multi-sipes 70 disposed in the shoulder land portion 33 are formed such that one end thereof is open to the circumferential main groove 20 or the shoulder portion narrow groove 60 and the other end thereof terminates within the shoulder land portion 33, and the plurality of multi-sipes 70 are disposed side by side in the tire circumferential direction along the circumferential main groove 20 or the shoulder portion narrow groove 60.

In the plurality of multi-sipes 70 disposed side by side in the tire circumferential direction in each of the land portions 30, a pitch length of the multi-sipes 70 adjacent to each other in the tire circumferential direction is within a range of 0.1% or more and 0.6% or less with respect to a tire circumferential length.

A circumferential narrow groove 40 and a lateral groove 50 are disposed in the center land portion 31 and the middle land portion 32 of the plurality of land portions 30 disposed in the tread portion 2. The circumferential narrow groove 40 referred to herein preferably has a groove width within a range of 0.1 mm or more and 2.0 mm or less, and the groove width is preferably within a range of 0.5 mm and 1.5 mm. The lateral groove 50 also preferably has a groove width within a range of 0.1 mm or more and 2.0 mm or less, and the groove width is preferably within a range of 0.5 mm and 1.5 mm.

A center circumferential narrow groove 41 that is a circumferential narrow groove 40, and a center lateral groove 51 that is a lateral groove 50 are disposed in the center land portion 31. The center circumferential narrow groove 41 is disposed at or near the center of the center land portion 31 in the tire width direction. The center circumferential groove 41 repeatedly undulates in the tire width direction while extending in the tire circumferential direction and thus is formed in a zigzag shape. The center lateral grooves 51 are disposed on both sides in the tire width direction of the center circumferential narrow groove 41 in the center land portion 31. The center lateral grooves 51 disposed on both sides in the tire width direction of the center circumferential narrow groove 41 each have one end communicating with the center circumferential narrow groove 41 and the other end communicating with the multi-sipe 70 disposed in the center land portion 31.

A middle circumferential narrow groove 42 that is a circumferential narrow groove 40, and a middle lateral groove 52 that is a lateral groove 50 are disposed in the middle land portion 32. The middle circumferential narrow groove 42 and the middle lateral groove 52 are disposed in each of the two middle land portions 32 located on both sides in the tire width direction of the tire equatorial plane CL. The middle circumferential narrow groove 42 is disposed at or near the center of the middle land portion 32 in the tire width direction. The middle circumferential narrow groove 42 repeatedly undulates in the tire width direction while extending in the tire circumferential direction and thus is formed in a zigzag shape. The middle lateral grooves 52 are disposed on both sides in the tire width direction of the middle circumferential narrow groove 42 in the middle land portion 32. The middle lateral grooves 52 disposed on both sides in the tire width direction of the middle circumferential narrow groove 42 each have one end communicating with the middle circumferential narrow groove 42 and the other end communicating with the multi-sipe 70 disposed in the middle land portion 32.

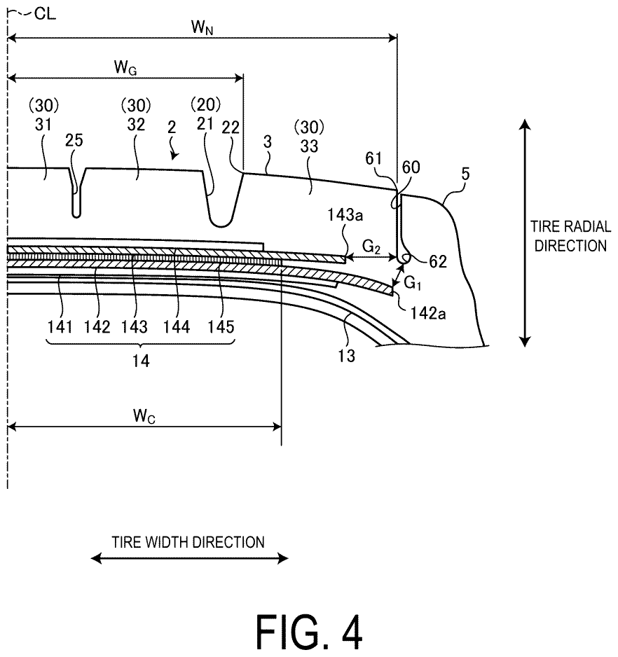

FIG. 4 is a detailed view of the tread portion 2 illustrating a region on one side from the tire equatorial plane CL in the tire width direction of the tread portion 2 illustrated in FIG. 1. The circumferential reinforcing layer 145 included in the belt layer 14 is disposed at a position in the tire width direction on an inner side in the tire width direction with respect to the shoulder portion narrow groove 60 disposed in the tread portion 2. Specifically, the circumferential reinforcing layer 145 and the shoulder portion narrow groove 60 are configured such that a distance W_{C} and a distance W_{N} satisfy a relationship 0.50≤W_{C}/W_{N}≤0.90, where W_{C} is a distance in the tire width direction from the tire equatorial plane CL to an end portion in the tire width direction of the circumferential reinforcing layer 145, and W_{N} is a distance in the tire width direction from the tire equatorial plane CL to an end portion 61 on an inner side in the tire width direction of the shoulder portion narrow groove 60.

A distance in the tire width direction between the tire equatorial plane CL and an end portion 22 on an outer side in the tire width direction of the circumferential main groove 20 located on the outermost side in the tire width direction of the plurality of circumferential main grooves 20 is defined as W_{G}, and the distance W_{C} and the distance W_{G} satisfy a relationship 1.00≤W_{C}/W_{G}≤1.40. In the present embodiment, only two circumferential main grooves 20 are disposed, and therefore, the two circumferential main grooves 20 are all outermost circumferential main grooves 21 that are the circumferential main grooves 20 located on the outermost side in the tire width direction. Therefore, the distance W_{G} between the tire equatorial plane CL and the end portion 22 on the outer side in the tire width direction of the circumferential main groove 20 located on the outermost side in the tire width direction is a distance in the tire width direction between the tire equatorial plane CL and the end portion 22 on the outer side in the tire width direction of each of the two outermost circumferential main grooves 21.

The relationship between the distance W_{C} and the distance W_{N} between the circumferential reinforcing layer 145 and the shoulder portion narrow groove 60 is preferably within a range of 0.60≤W_{C}/W_{N}≤0.80, and the relationship between the distance W_{C} and the distance W_{G} between the circumferential reinforcing layer 145 and the outermost circumferential main groove 21 is preferably within a range of 1.10≤W_{C}/W_{G}≤1.30.

A distance G₁ from an end portion 142a in the tire width direction of the inner cross belt 142 of the pair of cross belts 142 and 143 disposed on the inner side in the tire radial direction of the circumferential reinforcing layer 145 to a bottom portion 62 of the shoulder portion narrow groove 60 is within a range 7 mm≤G₁≤17 mm. A distance G₂ from an end portion 143a in the tire width direction of the outer cross belt 143 of the pair of cross belts 142 and 143 disposed on the outer side in the tire radial direction of the circumferential reinforcing layer 145 to the bottom portion 62 of the shoulder portion narrow groove 60 is within a range 10 mm≤G₂≤20 mm.

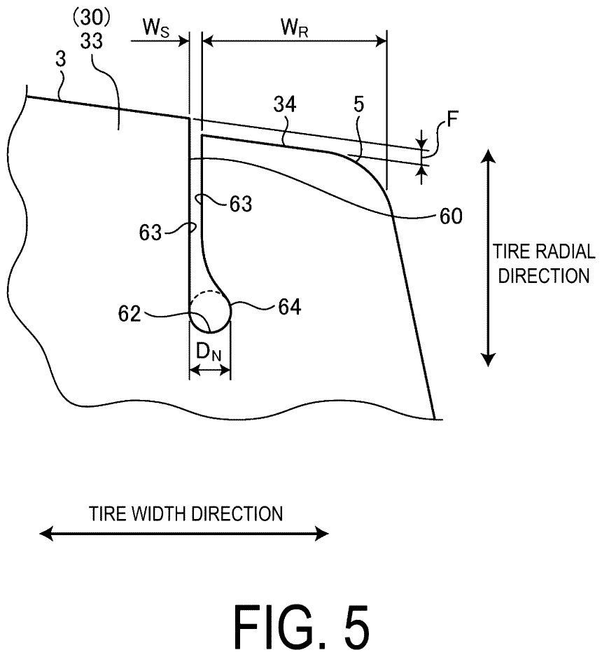

FIG. 5 is a detailed view of the shoulder portion narrow groove 60 illustrated in FIG. 4. The shoulder portion narrow groove 60 disposed in the shoulder land portion 33 is disposed at or near an end portion on an outer side in the tire width direction of the shoulder land portion 33. The shoulder portion narrow groove 60 is configured such that a distance W_{R} from an end portion on an outer side in the tire width direction of the shoulder land portion 33 to the shoulder portion narrow groove 60 is within a range 10 mm≤W_{R}≤18 mm.

The shoulder land portion 33 has a narrow rib 34 on an outer side in the tire width direction with respect to the shoulder portion narrow groove 60 by disposing the shoulder portion narrow groove 60 at or near an end portion on an outer side in the tire width direction. The narrow rib 34 is a rib-shaped portion extending in the tire circumferential direction with a relatively narrow width in the tire width direction, an inner portion in the tire width direction of the narrow rib 34 being defined by the shoulder portion narrow groove 60.

The tread ground contact surface 3 of the narrow rib 34 is offset inward in the tire radial direction as compared with a portion of the shoulder land portion 33 on an inner portion of the shoulder portion narrow groove 60 in the tire width direction. An offset amount F of the tread ground contact surface 3 of the narrow rib 34 with respect to the tread ground contact surface 3 of the portion of the shoulder land portion 33 on the inner portion of the shoulder portion narrow groove 60 in the tire width direction is within a range of 1.0 mm≤F≤4.0 mm.

The shoulder portion narrow groove 60 has a cylindrical portion 64 at a bottom portion 62, which has a width D_{N} in the groove width direction of the shoulder portion narrow groove 60 greater than a groove width W_{S} of the shoulder portion narrow groove 60 and extends in the tire circumferential direction in a cylindrical shape. The cylindrical portion 64 is formed at a position including the bottom portion 62 of the shoulder portion narrow groove 60, and is formed by the bottom portion 62 of the shoulder portion narrow groove 60 and a groove wall 63 in the vicinity of the bottom portion 62. The cylindrical portion 64 formed by the bottom portion 62 and the groove wall 63 is formed in a shape having a substantially cylindrical diameter by continuously curving the bottom portion 62 and the groove wall 63 in a cross-sectional view as viewed in the length direction of the shoulder portion narrow groove 60.

Specifically, the cylindrical portion 64 is formed in a curved shape in which at least one of a pair of groove walls 63 facing each other in the shoulder portion narrow groove 60 is recessed in a direction away from the other groove wall 63, and the bottom portion 62 and the groove wall 63 are continuous. In the present embodiment, the cylindrical portion 64 of the shoulder portion narrow groove 60 is formed such that one groove wall 63 of the pair of groove walls 63 facing each other with the bottom portion 62 interposed therebetween is recessed in a curved shape in a direction away from the other groove wall 63, and the other groove wall 63 is continuously curved from the bottom portion 62 without being recessed in a direction in which a distance between the groove walls 63 increases.

In the cylindrical portion 64 of the shoulder portion narrow groove 60 formed in this manner, the width D_{N} of the cylindrical portion 64 in the groove width direction of the shoulder portion narrow groove 60 is greater than the groove width W_{S} at a position other than the cylindrical portion 64 in the shoulder portion narrow groove 60. The width D_{N} of the cylindrical portion 64 in this case is a size of the diameter of the cylinder that is the shape of the cylindrical portion 64. The width D_{N} of the cylindrical portion 64 of the shoulder portion narrow groove 60 is within a range of 1.2 times or more and 5 times or less the groove width W_{S} at a position other than the cylindrical portion 64 in the shoulder portion narrow groove 60.

The groove width W_{S} at a position other than the cylindrical portion 64 in the shoulder portion narrow groove 60 is preferably within a range 1.0 mm≤W_{S}≤3.0 mm, and the width D_{N} of the cylindrical portion 64 of the shoulder portion narrow groove 60 is preferably within a range 2.0 mm≤D_{N}≤5.0 mm.

The pneumatic tire 1 according to the embodiment configured as described above has an aspect ratio of 80% or less. The aspect ratio referred to herein is a percentage of a ratio of a cross-sectional height of the pneumatic tire 1 to a cross-sectional width of the pneumatic tire 1. The cross-sectional width of the pneumatic tire 1 is a value obtained by excluding a pattern, characters, and the like on a side surface of the tire from a total width of the pneumatic tire 1 in the tire width direction. The cross-sectional height of the pneumatic tire 1 is ½ of a difference between an outer diameter of the pneumatic tire 1 and a diameter of a rim on which the pneumatic tire 1 is mounted.

When mounting the pneumatic tire 1 according to the present embodiment to a vehicle, the pneumatic tire 1 is mounted on a rim wheel and inflated with air inside to an inflated state and then mounted to the vehicle. When the vehicle on which the pneumatic tires 1 are mounted travels, the pneumatic tire 1 rotates with a lower portion of the tread ground contact surface 3 of the tread portion 2 in contact with a road surface. When the vehicle on which the pneumatic tires 1 are mounted travels on a dry road surface, the vehicle travels mainly by transmitting a driving force and a braking force to the road surface and generating a turning force by friction forces between the tread ground contact surface 3 and the road surface.

During traveling on a wet road surface, water between the tread ground contact surface 3 and the road surface enters grooves such as the circumferential main grooves 20, the circumferential narrow grooves 40, and the lateral grooves 50, and the vehicle travels while the water between the tread ground contact surface 3 and the road surface is drained by the grooves. This allows the tread ground contact surface 3 to easily contact the road surface and allows the vehicle to travel by the friction force between the tread ground contact surface 3 and the road surface.

The vehicle mounted with the pneumatic tires 1 travels with the tread ground contact surface 3 in contact with the road surface as described above, and thus the tread portion 2 gradually wears from the tread ground contact surface 3 side in the land portion 30. At this time, a portion of the tread ground contact surface 3 near the center in the tire width direction is likely to increase in outer diameter due to centrifugal force during rotation of the pneumatic tire 1 and is likely to contact the ground with a large ground contact pressure.

On the other hand, the portion of the tread ground contact surface 3 near the end portion in the tire width direction is likely to decrease in ground contact pressure due to a difference in outer diameter relative to the portion at or near the center in the tire width direction. Therefore, in the portion of the tread ground contact surface 3 near the end portion in the tire width direction, slippage is likely to occur between the tread ground contact surface 3 and the road surface due to a difference in ground contact pressure caused by the difference in outer diameter relative to the portion near the center in the tire width direction during rotation of the pneumatic tire 1, and wear is relatively likely to occur. The tread ground contact surface 3 is likely to be unevenly worn because the portion at or near the center and the portion at or near the end portion in the tire width direction are different in susceptibility to wear.

In contrast, in the pneumatic tire 1 according to the present embodiment, the belt layer 14 includes the circumferential reinforcing layer 145 that is formed with a width in the tire width direction narrower than the width of the pair of cross belts 142 and 143, and in which the inclination angle of the belt cords is 5 degrees or less. Therefore, the belt layer 14 can suppress the extension in the tire circumferential direction of the range in which the circumferential reinforcing layer 145 is disposed in the tire width direction by the circumferential reinforcing layer 145 and can suppress the increase in the outer diameter by the circumferential reinforcing layer 145 during the rotation of the pneumatic tire 1. This can suppress occurrence of uneven wear caused by the increase in the outer diameter of the portion at or near the center in the tire width direction during the rotation of the pneumatic tire 1.

On the other hand, when the rigidity at or near the center in the tire width direction is increased by disposing the circumferential reinforcing layer 145 at a position including the center in the tire width direction of the tread portion 2, there is a risk that the rigidity at or near the end portion in the tire width direction of the tread portion 2, that is, at or near the shoulder portion 5 of the tread portion 2 becomes excessively lower than the rigidity at or near the center in the tire width direction. In this case, due to the difference in rigidity of the tread portion 2, the load with respect to the rigidity becomes excessively large at or near the shoulder portion 5 of the tread portion 2 during traveling of the vehicle, and the ground contact pressure becomes locally excessive, so that there is a risk that a so-called rib tear, which is a failure in which the land portion 30 of the tread portion 2 is continuously torn off in the tire circumferential direction, is likely to occur.

In contrast, the pneumatic tire 1 according to the present embodiment includes the shoulder portion narrow groove 60 disposed on an outer side in the tire width direction of the circumferential main groove 20 disposed in the tread portion 2 and extending in the tire circumferential direction. This allows, at or near the shoulder portion 5 of the tread portion 2, the tread portion 2 to be likely to be deformed by the shoulder portion narrow groove 60 when a load is applied, thus preventing the ground contact pressure of the tread ground contact surface 3 from locally increasing. Therefore, it is possible to suppress the occurrence of rib tear that occur at or near the shoulder portion 5 due to the local increase in the ground contact pressure at or near the shoulder portion 5 caused by the load acting on the vicinity of the shoulder portion 5 of the tread portion 2.

Furthermore, in the pneumatic tire 1 according to the present embodiment, the circumferential reinforcing layer 145 is disposed between the pair of cross belts 142 and 143, and therefore, an increase in the difference in rigidity of the tread portion 2 can be more reliably suppressed. Since the belt cords of the pair of cross belts 142 and 143 have different inclination directions toward the tire width direction with respect to the tire circumferential direction, when the cross belts 142 and 143 are overlapped with each other, the pair of cross belts 142 and 143 can synergistically exhibit rigidity by restricting the movement of each other.

However, when the circumferential reinforcing layer 145 is overlapped with the pair of cross belts 142 and 143 while exhibiting a large rigidity by overlapping the pair of cross belts 142 and 143, there is a risk that the rigidity becomes excessively high due to the rigidity of the pair of cross belts 142 and 143 and the rigidity of the circumferential reinforcing layer 145 in the portion of the belt layer 14 where the circumferential reinforcing layer 145 is disposed. When the rigidity of the portion where the circumferential reinforcing layer 145 is disposed in the tire width direction becomes excessively high, the rigidity difference between the vicinity of the center of the tread portion 2 in the tire width direction and the vicinity of the shoulder portion 5 becomes excessively large, so that it becomes difficult to effectively suppress the local increase in the ground contact pressure at or near the shoulder portion 5, and thus there is a risk that it becomes difficult to effectively suppress the rib tear that occurs at or near the shoulder portion 5.

In contrast, in the pneumatic tire 1 according to the present embodiment, the circumferential reinforcing layer 145 is disposed between the pair of cross belts 142 and 143. This allows the rigidity of the range where the circumferential reinforcing layer 145 is disposed to be appropriately improved by the circumferential reinforcing layer 145 while suppressing the excessive increase in the rigidity exhibited by the pair of cross belts 142 and 143 restricting the movement of each other. That is, the belt layer 14 can provide improved rigidity at or near the center in the tire width direction by an appropriate magnitude without excessively increasing the rigidity by the circumferential reinforcing layer 145 disposed between the cross belts 142 and 143 with a width narrower than the pair of cross belts 142 and 143 and the cross belts 142 and 143 while securing the rigidity of the tread portion 2 in a wide range in the tire width direction by the pair of cross belts 142 and 143. This can suppress the excessive increase in the rigidity difference between the vicinity of the center of the tread portion 2 in the tire width direction and the vicinity of the shoulder portion 5, and can effectively suppress the occurrence of rib tear starting from the shoulder portion narrow groove 60 in the shoulder portion 5.

Furthermore, the circumferential reinforcing layer 145 and the shoulder portion narrow groove 60 are configured such that the distance W_{C} in the tire width direction from the tire equatorial plane CL to the end portion in the tire width direction of the circumferential reinforcing layer 145 and the distance Wx in the tire width direction from the tire equatorial plane CL to the end portion 61 on the inner side in the tire width direction of the shoulder portion narrow groove 60 satisfy the relationship 0.50≤W_{C}/W_{N}≤0.90, and therefore, the occurrence of rib tear at or near the shoulder portion 5 can be suppressed while suppressing uneven wear at or near the shoulder portion 5 of the tread portion 2.

That is, when the relationship between the distance W_{C} and the distance W_{N} is W_{C}/W_{N}<0.50, the distance W_{C} is small with respect to the distance W_{N}, and the width of the circumferential reinforcing layer 145 in the tire width direction is excessively narrow, and therefore, there is a risk that it is difficult to appropriately improve the rigidity at or near the center in the tire width direction by the circumferential reinforcing layer 145. In this case, it is difficult to suppress the increase in the outer diameter at or near the center in the tire width direction by the circumferential reinforcing layer 145 during the rotation of the pneumatic tire 1, and thus, there is a risk that it is difficult to suppress the occurrence of uneven wear at or near the shoulder portion 5 caused by the increase in the outer diameter at or near the center in the tire width direction. When the relationship between the distance W_{C} and the distance W_{N} is W_{C}/W_{N}>0.90, the distance W_{C} is large with respect to the distance Wx, and the width of the circumferential reinforcing layer 145 in the tire width direction is excessively wide, and therefore there is a risk that the region in which the rigidity of the tread portion 2 is improved by the circumferential reinforcing layer 145 extends to the vicinity of the shoulder portion 5. In this case, the portion of the tread portion 2 where the rigidity changes depending on the presence or absence of the circumferential reinforcing layer 145 is located at or near the shoulder portion 5 of the tread portion 2, and therefore, there is a risk that, due to the portion where the rigidity changes being located at or near the shoulder portion 5, the load with respect to the rigidity is likely to increase in the portion where the rigidity is low. This causes the ground contact pressure to be likely to increase locally at or near the shoulder portion 5, and it may thus be difficult to suppress the occurrence of rib tear starting from the shoulder portion narrow groove 60.

In contrast, when the relationship between the distance W_{C} and the distance W_{N} is within the range of 0.50≤W_{C}/W_{N}≤0.90, the portion where the rigidity of the tread portion 2 changes depending on the presence or absence of the circumferential reinforcing layer 145 is not located at or near the shoulder portion 5, and the rigidity at or near the center in the tire width direction can be improved by the circumferential reinforcing layer 145. This can suppress the occurrence of rib tear caused by a local increase in the ground contact pressure at or near the shoulder portion 5 while suppressing uneven wear in which the vicinity of the shoulder portion 5 of the tread portion 2 wears earlier than the portion at or near the center in the tire width direction. As a result, it is possible to improve the uneven wear resistance while suppressing the rib tear in the shoulder region that is a region at or near the shoulder portion 5 of the tread portion 2.

The circumferential reinforcing layer 145 and the outermost circumferential main groove 21 are configured such that the distance W_{C} in the tire width direction from the tire equatorial plane CL to the end portion in the tire width direction of the circumferential reinforcing layer 145 and the distance W_{G} in the tire width direction between the tire equatorial plane CL and the end portion 22 on the outer side in the tire width direction of the outermost circumferential main groove 21 satisfy the relationship 1.00≤W_{C}/W_{G}≤1.40, and therefore, the occurrence of rib tear at or near the shoulder portion 5 can be suppressed while suppressing uneven wear at or near the shoulder portion 5 of the tread portion 2.

That is, when the relationship between the distance W_{C} and the distance W_{G} is W_{C}/W_{G}<1.00, the distance W_{C} is small with respect to the distance W_{G}, and the width of the circumferential reinforcing layer 145 in the tire width direction is excessively narrow, and therefore, there is a risk that it is difficult to appropriately improve the rigidity at or near the center in the tire width direction by the circumferential reinforcing layer 145. In this case, it is difficult to suppress the increase in the outer diameter at or near the center in the tire width direction by the circumferential reinforcing layer 145 during the rotation of the pneumatic tire 1, and thus, there is a risk that it is difficult to suppress the occurrence of uneven wear at or near the shoulder portion 5 caused by the increase in the outer diameter at or near the center in the tire width direction. When the relationship between the distance W_{C} and the distance W_{G} is W_{C}/W_{G}>1.40, the distance W_{C} is large with respect to the distance W_{G}, and the width of the circumferential reinforcing layer 145 in the tire width direction is excessively wide, and therefore there is a risk that the region in which the rigidity of the tread portion 2 is improved by the circumferential reinforcing layer 145 extends to the vicinity of the shoulder portion 5. In this case, the portion of the tread portion 2 where the rigidity changes depending on the presence or absence of the circumferential reinforcing layer 145 is located at or near the shoulder portion 5 of the tread portion 2, and therefore, there is a risk that, due to the portion where the rigidity changes being located at or near the shoulder portion 5, the load with respect to the rigidity is likely to increase in the portion where the rigidity is low. This causes the ground contact pressure to be likely to increase locally at or near the shoulder portion 5, and it may thus be difficult to suppress the occurrence of rib tear starting from the shoulder portion narrow groove 60.

In contrast, when the relationship between the distance W_{C} and the distance W_{G} is within the range of 1.00≤W_{C}/W_{G}≤1.40, the portion where the rigidity of the tread portion 2 changes depending on the presence or absence of the circumferential reinforcing layer 145 is not located at or near the shoulder portion 5, and the rigidity at or near the center in the tire width direction can be improved by the circumferential reinforcing layer 145. This can suppress the occurrence of rib tear caused by a local increase in the ground contact pressure at or near the shoulder portion 5 while suppressing uneven wear in which the vicinity of the shoulder portion 5 of the tread portion 2 wears earlier than the portion at or near the center in the tire width direction. As a result, it is possible to improve the uneven wear resistance while suppressing the rib tear in the shoulder region.

The pair of cross belts 142 and 143 are configured such that the distance G₁ from the end portion 142a in the tire width direction of the inner cross belt 142 to the bottom portion 62 of the shoulder portion narrow groove 60 is within the range 7 mm≤G₁≤17 mm, and the distance G₂ from the end portion 143a in the tire width direction of the outer cross belt 143 to the bottom portion 62 of the shoulder portion narrow groove 60 is within the range 10 mm≤G₂≤20 mm, and therefore, it is possible to suppress the occurrence of rib tear starting from the shoulder portion narrow groove 60 while suppressing uneven wear at or near the shoulder portions 5 of the tread portion 2.

That is, when the distance G₁ from the end portion 142a of the inner cross belt 142 to the bottom portion 62 of the shoulder portion narrow groove 60 is G₁≤7 mm, or the distance G₂ from the end portion 143a of the outer cross belt 143 to the bottom portion 62 of the shoulder portion narrow groove 60 is G₂<10 mm, the distance between the inner cross belt 142 or the outer cross belt 143 and the shoulder portion narrow groove 60 is excessively small, and thus, there is a risk that stress is likely to concentrate between the inner cross belt 142 or the outer cross belt 143 and the shoulder portion narrow groove 60. In this case, there is a risk that rib tear starting from the shoulder portion narrow groove 60 is likely to occur due to the stress concentration. When the distance G₁ from the end portion 142a of the inner cross belt 142 to the bottom portion 62 of the shoulder portion narrow groove 60 is G₁>17 mm, or the distance G₂ from the end portion 143a of the outer cross belt 143 to the bottom portion 62 of the shoulder portion narrow groove 60 is G₂>20 mm, the distance between the inner cross belt 142 or the outer cross belt 143 and the shoulder portion narrow groove 60 is excessively large, and thus, there is a risk that the width in the tire width direction of the cross belt 142, 143 is excessively narrow. In this case, the range in which the rigidity of the tread portion 2 is secured by the cross belts 142 and 143 is narrowed, and it becomes difficult to secure the rigidity at or near the center in the tire width direction by the cross belts 142 and 143, and therefore, there is a risk that it becomes difficult to suppress the increase in the outer diameter at or near the center in the tire width direction by the cross belts 142 and 143 during the rotation of the pneumatic tire 1, and it becomes difficult to suppress the occurrence of uneven wear at or near the shoulder portion 5. In contrast, when the distance G₁ from the end portion 142a of the inner cross belt 142 to the bottom portion 62 of the shoulder portion narrow groove 60 is within the range 7 mm≤G₁≤17 mm, and the distance G₂ from the end portion 143a of the outer cross belt 143 to the bottom portion 62 of the shoulder portion narrow groove 60 is within the range 10 mm≤G₂≤20 mm, it is possible to improve the rigidity at or near the center in the tire width direction by the cross belts 142 and 143 while suppressing the occurrence of stress concentration between the inner cross belt 142 or the outer cross belt 143 and the shoulder portion narrow groove 60. This can suppress the occurrence of rib tear starting from the shoulder portion narrow groove 60 while suppressing uneven wear in which the vicinity of the shoulder portion 5 of the tread portion 2 wears earlier than the portion at or near the center in the tire width direction. As a result, it is possible to improve the uneven wear resistance while suppressing the rib tear in the shoulder region.

Since the circumferential reinforcing layer 145 has the number of ends of the belt cords within the range of 15 cords/50 mm or more and 30 cords/50 mm or less, it is possible to suppress the occurrence of rib tear starting from the shoulder portion narrow groove 60 while suppressing uneven wear at or near the shoulder portion 5 of the tread portion 2. That is, if the number of ends of the belt cords of the circumferential reinforcing layer 145 is less than 15 cords/50 mm, the number of ends of the belt cords is excessively small, and thus, there is a risk that it is difficult to secure the rigidity of the circumferential reinforcing layer 145. In this case, it is difficult to appropriately improve the rigidity at or near the center in the tire width direction by the circumferential reinforcing layer 145 and to suppress the increase in the outer diameter at or near the center in the tire width direction by the circumferential reinforcing layer 145 during the rotation of the pneumatic tire 1, and thus, there is a risk that it is difficult to suppress the occurrence of uneven wear at or near the shoulder portion 5 caused by the increase in the outer diameter at or near the center in the tire width direction. If the number of ends of the belt cords of the circumferential reinforcing layer 145 is more than 30 cords/50 mm, the number of ends of the belt cords is excessively large, and thus, there is a risk that the rigidity of the circumferential reinforcing layer 145 becomes excessively large. In this case, the difference in rigidity between the portion where the circumferential reinforcing layer 145 is disposed and the portion other than the portion where the circumferential reinforcing layer 145 is disposed in the tire width direction becomes excessively large, and thus the load with respect to the rigidity becomes excessively large at or near the shoulder portion 5 of the tread portion 2, and there is a risk that it becomes difficult to suppress the occurrence of rib tear starting from the shoulder portion narrow groove 60.

In contrast, when the number of ends of the belt cords of the circumferential reinforcing layer 145 is within the range of 15 cords/50 mm or more and 30 cords/50 mm or less, the rigidity of the circumferential reinforcing layer 145 is secured, and the rigidity difference between the portion where the circumferential reinforcing layer 145 is disposed and the portion other than the portion where the circumferential reinforcing layer 145 is disposed can be suppressed from becoming excessively large. This can suppress the occurrence of rib tear starting from the shoulder portion narrow groove 60 while suppressing uneven wear in which the vicinity of the shoulder portion 5 of the tread portion 2 wears earlier than the portion at or near the center in the tire width direction. As a result, it is possible to improve the uneven wear resistance while providing a suppressed rib tear in the shoulder region.

Since the shoulder portion narrow groove 60 has the cylindrical portion 64 at the bottom portion 62, even when a load is applied at or near the shoulder portion narrow groove 60 during traveling of the vehicle, the cylindrical portion 64 can alleviate deformation generated at the bottom portion 62 of the shoulder portion narrow groove 60 due to the load. That is, the stress concentration that occurs at the bottom portion 62 when a load is applied at or near the shoulder portion narrow groove 60 can be suppressed by the cylindrical portion 64. This can suppress the occurrence of rib tear starting from the bottom portion 62 of the shoulder portion narrow groove 60 even when a load is applied at or near the shoulder portion 5 of the tread portion 2. As a result, it is possible to suppress the occurrence of rib tear in the shoulder region.

Since only two circumferential main grooves 20 are disposed in the tread portion 2, the ground contact area at or near the center in the tire width direction can be increased. This allows most of the load applied to the tread portion 2 to be received at or near the center in the tire width direction and allows the load received at or near the shoulder portion 5 to be relatively reduced, thus reducing the ground contact pressure at or near the shoulder portion 5. This can suppress the vicinity of the shoulder portion 5 of the tread portion 2 from wearing earlier than the portion at or near the center in the tire width direction. As a result, it is possible to suppress uneven wear caused by early wear of the shoulder region.

In the pneumatic tire 1 according to the embodiment, since the aspect ratio is 80% or less, uneven wear of the tread portion 2 can be effectively suppressed by the circumferential reinforcing layer 145. That is, in the pneumatic tire 1 having an aspect ratio of 80% or less, the filling internal pressure is high, and thus the share of the internal pressure borne by the belt layer 14 tends to increase, and the contribution of the belt layer 14 to the rigidity of the tread portion 2 tends to become greater. Therefore, the rigidity of the belt layer 14 can be effectively improved by disposing the circumferential reinforcing layer 145 in the belt layer 14, and therefore, even in the pneumatic tire 1 having an aspect ratio of 80% or less, it is possible to suppress an increase in the outer diameter at or near the center in the tire width direction during rotation of the pneumatic tire 1. This can suppress uneven wear in which the vicinity of the shoulder portion 5 of the tread portion 2 wears earlier than the portion at or near the center in the tire width direction, even in the pneumatic tire 1 having an aspect ratio of 80% or less. As a result, uneven wear resistance can be improved.

### MODIFIED EXAMPLES

In the above-described embodiment, the shoulder portion narrow groove 60 has the cylindrical portion 64 at the bottom portion 62, but the shoulder portion narrow groove 60 may not have the cylindrical portion 64. The shoulder portion narrow groove 60 may be formed to have a constant groove width.

In the above-described embodiment, the number of circumferential main grooves 20 disposed in the tread portion 2 is two, but the number of circumferential main grooves 20 may be other than two. For example, the chamfered circumferential narrow groove 25 in the embodiment may be replaced with the circumferential main groove 20, so that four circumferential main grooves 20 may be disposed.

In the embodiment described above, although the pneumatic tire 1 is used for description as an example of the tire according to the embodiment of the present technology, the tire according to the embodiment of the present technology may be a tire other than the pneumatic tire 1. The tire according to the embodiment of the present technology may be, for example, a so-called airless tire that can be used without filling a gas.

### Examples

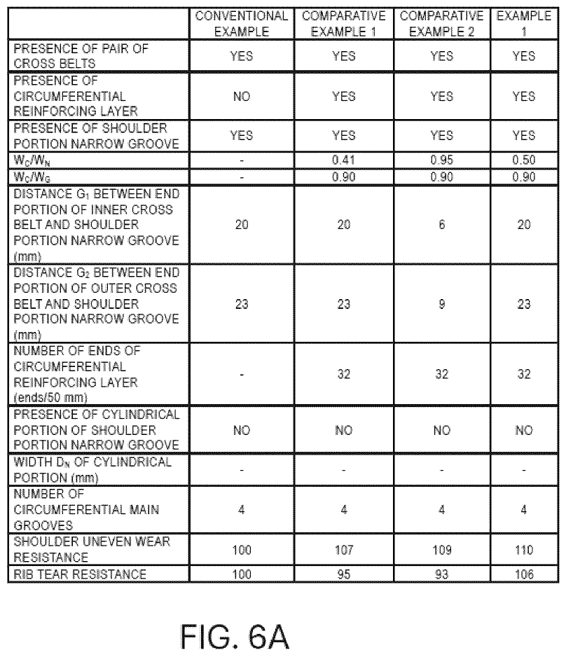

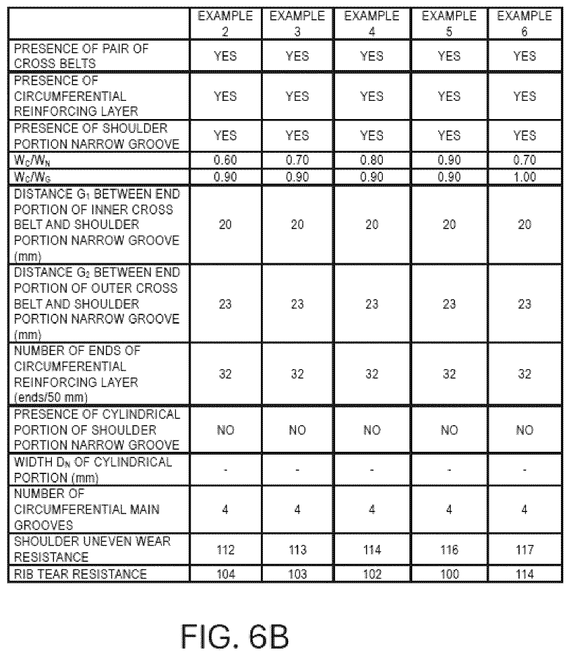

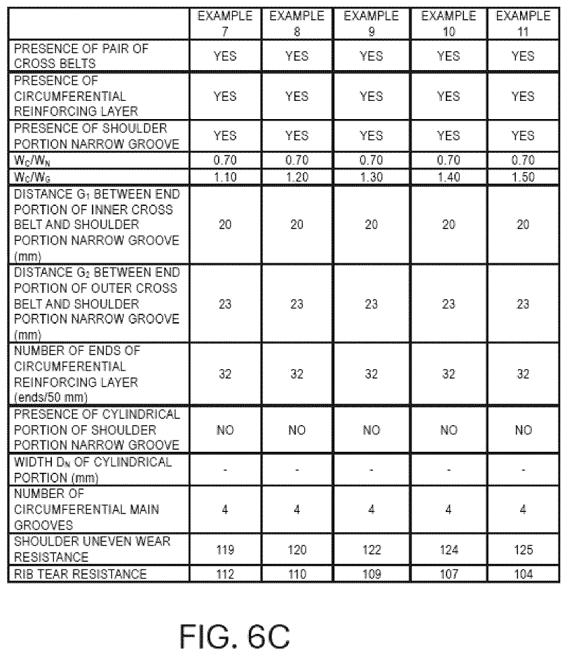

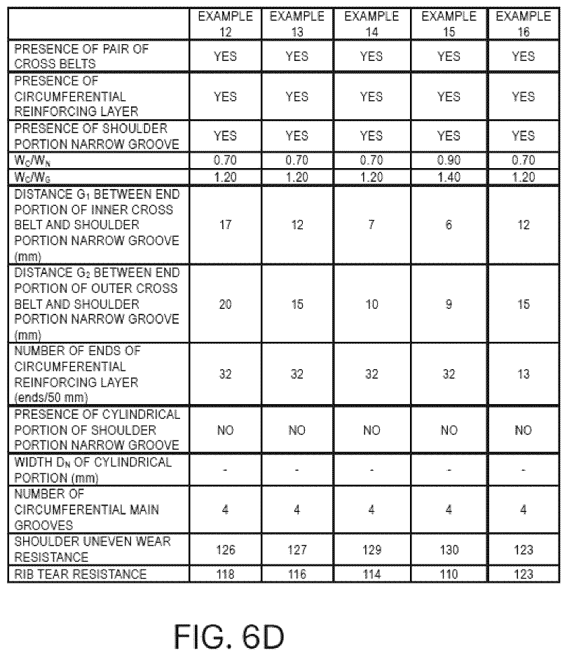

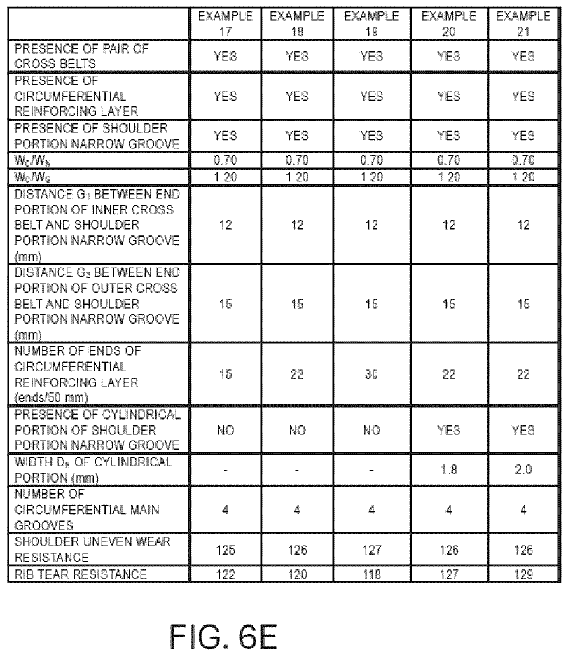

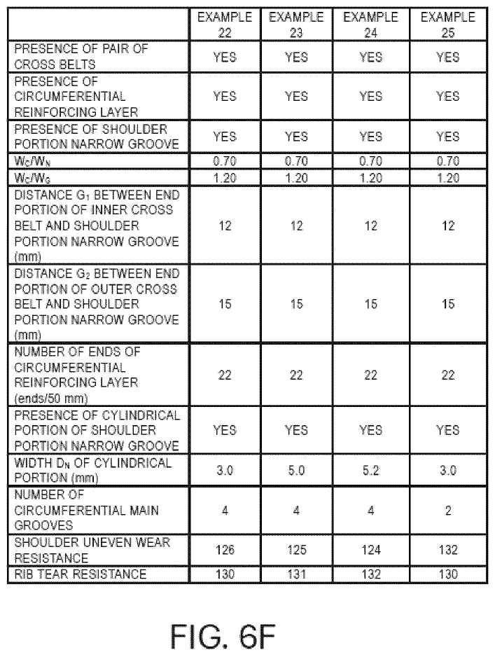

FIG. 6A-6F are tables indicating results of performance evaluation tests of pneumatic tires. In relation to the pneumatic tire 1 described above, description will be given of performance evaluation tests conducted on a pneumatic tire according to Conventional Example, the pneumatic tires 1 according to embodiments of the present technology, and pneumatic tires according to Comparative Examples to be compared with pneumatic tires 1 according to the embodiments of the present technology. For performance evaluation tests, tests on shoulder uneven wear resistance and rib tear resistance were performed.

The performance evaluation tests were conducted by mounting the pneumatic tires 1, having a nominal size of 295/75R22.5 as specified by TRA (The Tire & Rim Association, Inc.), on rim wheels of regular rims specified by TRA, adjusting the air pressure to the maximum air pressure specified by TRA, and mounting the rim wheels on a 2-DD test vehicle (tractor head) to perform test traveling.

The evaluation method for each test item was as follows: after traveling 100000 km with the test vehicle mounted with the test tires, the degree of occurrence of shoulder uneven wear, which is uneven wear of the shoulder land portion 33 relative to the center land portion 31 and the middle land portion 32, was measured, and the measured degree of occurrence of shoulder uneven wear was expressed as an index with the value of Conventional Example described below being 100. The shoulder uneven wear resistance indicates that the larger the value of the index, the smaller the degree of occurrence of shoulder uneven wear, indicating excellent shoulder uneven wear resistance.

The rib tear resistance was evaluated by driving the test vehicle mounted with the test tires over a step having a height of 50 cm twenty times and measuring the number of rib tears generated in the shoulder land portion 33 and the size of the rib tear. The rib tear resistance was evaluated by comprehensively expressing the number of rib tears generated and the reciprocal of the size of the rib tear as indices with the value of Conventional Example described below being 100. The rib tear resistance indicates that the larger the index, the smaller the number of rib tears generated, and the smaller the size of the rib tear, indicating excellent rib tear resistance.

The performance evaluation tests were performed on twenty eight types of pneumatic tires that are a pneumatic tire of Conventional Example as an example of a conventional pneumatic tire, pneumatic tires of Examples 1 to 25 corresponding to the pneumatic tire 1 according to an embodiment of the present technology, and pneumatic tires of Comparative Examples 1 and 2 compared with the pneumatic tire 1 according to an embodiment of the present technology. Among these, the pneumatic tire of Conventional Example has the shoulder portion narrow groove but does not have the circumferential reinforcing layer. In the pneumatic tires of Comparative Examples 1 and 2, the distance W_{C} from the tire equatorial plane to the end portion of the circumferential reinforcing layer and the distance W_{N} from the tire equatorial plane to the shoulder portion narrow groove do not satisfy the relationship 0.50≤W_{C}/W_{N}≤0.90.

In contrast, all of Examples 1 to 25, which are examples of the pneumatic tire 1 according to the present technology, include the circumferential reinforcing layer 145 and the shoulder portion narrow groove 60, and the distance W_{C} from the tire equatorial plane CL to the end portion of the circumferential reinforcing layer 145 and the distance W_{N} from the tire equatorial plane CL to the shoulder portion narrow groove 60 satisfy the relationship 0.50≤W_{C}/W_{N}≤0.90. Furthermore, the pneumatic tires 1 according to Examples 1 to 25 differ from each other in the ratio (W_{C}/W_{G}) of the distance W_{C} from the tire equatorial plane CL to the end portion of the circumferential reinforcing layer 145 to the distance W_{G} from the tire equatorial plane CL to the end portion 22 of the outermost circumferential main groove 21, the distance G₁ (mm) from the end portion 142a of the inner cross belt 142 to the shoulder portion narrow groove 60, the distance G₂ from the end portion 143a of the outer cross belt 143 to the shoulder portion narrow groove 60, the number of ends (ends/50 mm) of the circumferential reinforcing layer 145, the presence or absence of the cylindrical portion 64 of the shoulder portion narrow groove 60, the width D_{N} of the cylindrical portion 64 of the shoulder portion narrow groove 60, and the number of circumferential main grooves 20.

As a result of performing the evaluation test using these pneumatic tires 1, as indicated in FIGS. 6A-6F, it has been found that the pneumatic tires 1 according to Examples 1 to 25 can provide improved shoulder uneven wear resistance performance and rib tear resistance performance as compared with Conventional Example and Comparative Examples 1 and 2. That is, the pneumatic tires 1 according to Examples 1 to 25 can provide improved uneven wear resistance while providing a suppressed rib tear in the shoulder region.

The present disclosure includes the following technologies.

### Technology [1]

A tire, including:
a tread portion including a plurality of circumferential main grooves extending in a tire circumferential direction; and,
a belt layer disposed in the tread portion and including a plurality of belt plies, the belt layer including
a pair of cross belts each including belt cords whose inclination directions toward a tire width direction with respect to a tire circumferential direction are opposite to each other, and,
a circumferential reinforcing layer disposed between the pair of cross belts, having a width in the tire width direction smaller than a width of the cross belts, and having an inclination angle of the belt cords in the tire width direction with respect to the tire circumferential direction of 5 degrees or less,
the tread portion including a shoulder portion narrow groove disposed on an outer side in the tire width direction of a circumferential main groove of the circumferential main grooves and extending in the tire circumferential direction,
a distance in the tire width direction from a tire equatorial plane to an end portion in the tire width direction of the circumferential reinforcing layer being defined as W_{C}, a distance in the tire width direction from the tire equatorial plane to an end portion on an inner side in the tire width direction of the shoulder portion narrow groove being defined as W_{N}, and
a distance W_{C} and a distance W_{N} satisfy a relationship 0.50≤W_{C}/W_{N}≤0.90.

### Technology [2]

The tire according to Technology [1], wherein a distance in the tire width direction between the tire equatorial plane and an end portion on an outer side in the tire width direction of the circumferential main groove located on an outermost side in the tire width direction of the plurality of circumferential main grooves is defined as W_{G}, and the distance W_{C} and the distance W_{G} satisfy a relationship 1.00≤W_{C}/W_{G}≤1.40.

### Technology [3]

The tire according to Technology [1] or [2], wherein a distance from an end portion in the tire width direction of a cross belt of the pair of cross belts disposed on an inner side in a tire radial direction of the circumferential reinforcing layer to a bottom portion of the shoulder portion narrow groove is defined as G₁,
a distance from an end portion in the tire width direction of a cross belt of the pair of cross belts disposed on an outer side in the tire radial direction of the circumferential reinforcing layer to the bottom portion of the shoulder portion narrow groove is defined as G₂,
the distance G₁ is within a range 7 mm≤G₁≤17 mm, and,
the distance G₂ is within a range 10 mm≤G₂≤20 mm.

### Technology [4]

The tire according to any one of Technologies [1] to [3], wherein the belt cords of the circumferential reinforcing layer are made of steel wire, and the number of ends of the belt cords of the circumferential reinforcing layer is within a range of 15 cords/50 mm or more and 30 cords/50 mm or less.

### Technology [5]

The tire according to any one of Technologies [1] to [4], wherein the shoulder portion narrow groove includes, at a bottom portion, a cylindrical portion having a width in a groove width direction of the shoulder portion narrow groove greater than a groove width of the shoulder portion narrow groove, having a cylindrical shape, and extending in the tire circumferential direction.

### Technology [6]

The tire according to any one of Technologies [1] to [5], wherein only two of the circumferential main grooves are disposed.

### Technology [7]

The tire according to any one of Technologies [1] to [6], wherein the tire has an aspect ratio of 80% or less.

1. A tire, comprising:
a tread portion comprising a plurality of circumferential main grooves extending in a tire circumferential direction; and,
a belt layer disposed in the tread portion and comprising a plurality of belt plies; the belt layer comprising
a pair of cross belts each comprising belt cords whose inclination directions toward a tire width direction with respect to a tire circumferential direction are opposite to each other, and,
a circumferential reinforcing layer disposed between the pair of cross belts, having a width in the tire width direction smaller than a width of the cross belts, and having an inclination angle of the belt cords in the tire width direction with respect to the tire circumferential direction of 5 degrees or less,
the tread portion comprising a shoulder portion narrow groove disposed on an outer side in the tire width direction of a circumferential main groove of the circumferential main grooves and extending in the tire circumferential direction,
a distance in the tire width direction from a tire equatorial plane to an end portion in the tire width direction of the circumferential reinforcing layer being defined as W_{C}, a distance in the tire width direction from the tire equatorial plane to an end portion on an inner side in the tire width direction of the shoulder portion narrow groove being defined as W_{N}, and,
a distance W_{C} and a distance W_{N} satisfying a relationship 0.50≤W_{C}/W_{N}≤0.90.

2. The tire according to claim 1, wherein a distance in the tire width direction between the tire equatorial plane and an end portion on an outer side in the tire width direction of the circumferential main groove located on an outermost side in the tire width direction of the plurality of circumferential main grooves is defined as W_{G}, and the distance W_{C} and the distance W_{G} satisfy a relationship 1.00≤W_{C}/W_{G}≤1.40.

3. The tire according to claim 1, wherein a distance from an end portion in the tire width direction of a cross belt of the pair of cross belts disposed on an inner side in a tire radial direction of the circumferential reinforcing layer to a bottom portion of the shoulder portion narrow groove is defined as G₁,
a distance from an end portion in the tire width direction of a cross belt of the pair of cross belts disposed on an outer side in the tire radial direction of the circumferential reinforcing layer to the bottom portion of the shoulder portion narrow groove is defined as G₂,
the distance G₁ is within a range 7 mm≤G₁≤17 mm, and
the distance G₂ is within a range 10 mm≤G₂≤20 mm.

4. The tire according to claim 1, wherein the belt cords of the circumferential reinforcing layer are made of steel wire, and
the number of ends of the belt cords of the circumferential reinforcing layer is within a range of 15 cords/50 mm or more and 30 cords/50 mm or less.

5. The tire according to claim 1, wherein the shoulder portion narrow groove comprises, at a bottom portion, a cylindrical portion having a width in a groove width direction of the shoulder portion narrow groove greater than a groove width of the shoulder portion narrow groove, having a cylindrical shape, and extending in the tire circumferential direction.

6. The tire according to claim 1, wherein only two of the circumferential main grooves are disposed.

7. The tire according to claim 1, wherein the tire has an aspect ratio of 80% or less.
